(19) United States
(12) Patent Application Publication
(10) Pub. No.: US 2013/0061724 A1
(43) Pub. Date: Mar. 14, 2013

(54) HANDLE FOR A HAND TOOL

(71) Applicant: Chia-Szu LIN, Taichung City (TW)

(72) Inventor: Chia-Szu LIN, Taichung City (TW)

(21) Appl. No.: 13/231,092

(22) Filed: Sep. 13, 2011

(51) Int. Cl. B25G 1/10

(52) U.S. Cl. 81/489

(57) ABSTRACT

A handle for a hand tool has a held section and a connecting section connected with the held section. The held section has at least one soft area and at least one hard area that are formed on an outer surface of the held section. The connecting section has an end surface and a shank hole. The end surface of the connecting section is opposite to the held section. The shank hole is formed in the end surface of the connecting section and has an axis. A cross section of the held section is asymmetric relative to the axis of the shank hole. The cross section of the held section is asymmetric and ergonomic, so the held section is suitable for the user's hand to turn.

### BACKGROUND OF THE INVENTION

1. Field of the Invention

The present invention relates to a handle for a hand tool, and more particularly to a handle for a hand tool that can be easily held and turned.

2. Description of Related Art

With reference to FIGS. 6 to 9, conventional handles 80,90 for hand tools respectively have a cross section and an axis C. The cross section of each conventional handle 80,90 is symmetric relative to the axis of the handle 80,90.

However, an inner shape of a hand that holds the handle 80,90 is asymmetric and the handle 80,90 is difficult to be held and turned. Because the conventional handle 80,90 is difficult to be held and turned, the handle 80,90 further has multiple flutes 81 or a rough surface 91 to increase friction. Nevertheless, processing the flutes 81 or the rough surface 91 takes time and manufacturing the handles 80,90 is not convenient and fast.

To overcome the shortcomings, the present invention tends to provide a handle for a hand tool to mitigate the aforementioned problems.

### SUMMARY OF THE INVENTION

The main objective of the invention is to provide a handle for a hand tool that can be easily held and turned.

A handle for a hand tool has a held section and a connecting section connected with the held section. The held section has at least one soft area and at least one hard area that are formed on an outer surface of the held section. The connecting section has an end surface and a shank hole. The end surface of the connecting section is opposite to the held section. The shank hole is formed in the end surface of the connecting section and has an axis. A cross section of the held section is asymmetric relative to the axis of the shank hole. The cross section of the held section is asymmetric and ergonomic, so the held section is suitable for the user's hand to turn.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a handle for a hand tool in accordance with the present invention;

FIG. 2 is another perspective view of the handle for a hand tool in FIG. 1;

FIG. 3 is a top view of the handle for a hand tool in FIG. 1;

FIG. 4 is a bottom view of the handle for a hand tool in FIG. 1;

FIG. 5 is an operational view of the handle for a hand tool in FIG. 1;

FIG. 6 is a perspective view of a conventional handle in accordance with the prior art;

FIG. 7 is a top view of the conventional handle in FIG. 6;

FIG. 8 is a perspective view of another conventional handle in accordance with the prior art; and

FIG. 9 is a top view of the conventional handle in FIG. 8.

### DETAILED DESCRIPTION OF PREFERRED EMBODIMENT

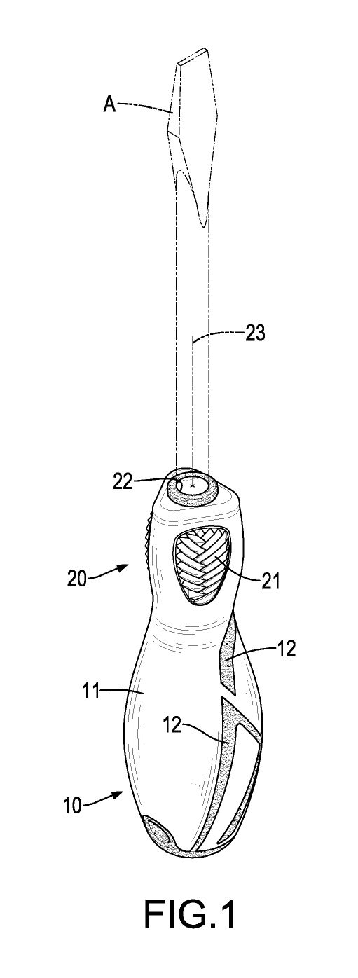

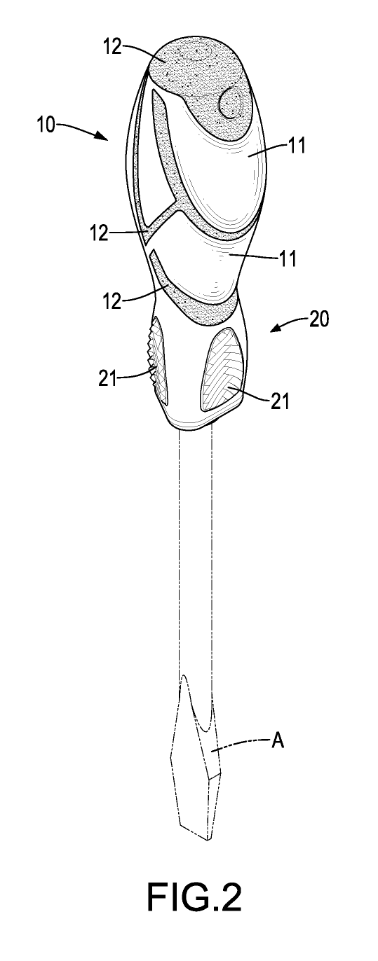

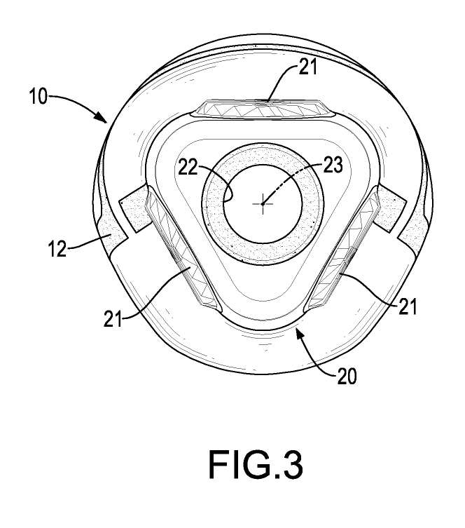

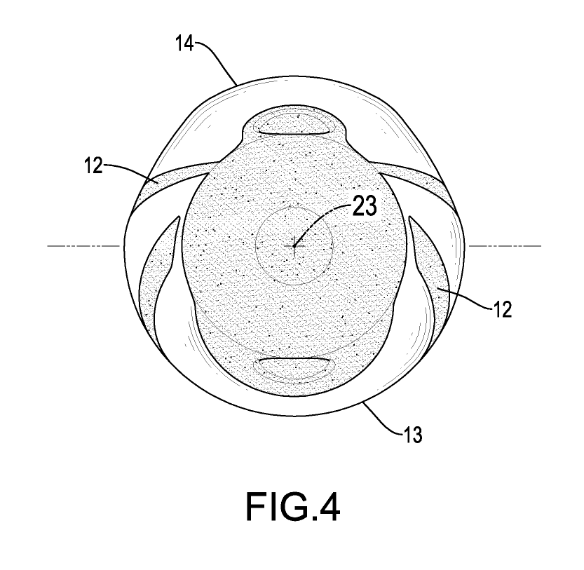

With reference to FIGS. 1 to 4, a handle for a hand tool in accordance with the present invention is an elongated grip covered by a soft pad and comprises a held section 10 and a connecting section 20.

The held section 10 has an outer surface, a cross section, multiple soft areas 11 and multiple hard areas 12. The soft areas 11 are formed on the outer surface of the held section 10. The hard areas 12 are strips and are formed on the outer surface of the held section 10 beside the soft areas 11.

Preferably, a rim of the cross section of the held section 10 has a first arc 13 and a second arc 14. The first arc 13 has a length and a curvature. The second arc 14 has a length and a curvature. The length of the second arc 14 is shorter than that of the first arc 13. The curvature of the second arc 14 is different from that of the first arc 13.

The connecting section 20 is connected with the held section 10 and has an outer surface, an end surface, multiple finger areas 21 and a shank hole 22.

The end surface of the connecting section 20 is opposite to the held section 10.

The finger areas 21 are formed on the outer surface of the connecting section 20, and each finger area 21 has multiple notches. Preferably, the finger areas 21 are arranged around the outer surface of the connecting section 20 at intervals. Each finger area 21 protrudes from the outer surface of the connecting section 20. With the protrusions of the finger areas 21, the finger areas 21 can be easily pressed by a user.

Preferably, three finger areas 21 are implemented and a cross section of the connecting section 20 is triangular.

The shank hole 22 is formed in the end surface of the connecting section 20 and has an axis 23. The cross section of the held section 10 is asymmetric relative to the axis 23 of the shank hole 22. The shank hole 22 is used to be inserted by a metal shank of a hand tool A.

With reference to FIGS. 1, 4 and 5, the held section 10 of the handle in accordance with the present invention is held by a user. Because the cross section of the held section 10 is asymmetric and is ergonomically designed, the held section 10 is suitable for the user's hand to turn.

When the held section 10 is held, the soft areas 11 can be compressed slightly and the hard areas 12 are not compressed. Accordingly, height differences (gaps) between the soft areas 11 and the hard areas 12 are formed to facilitate the user's holding the handle.

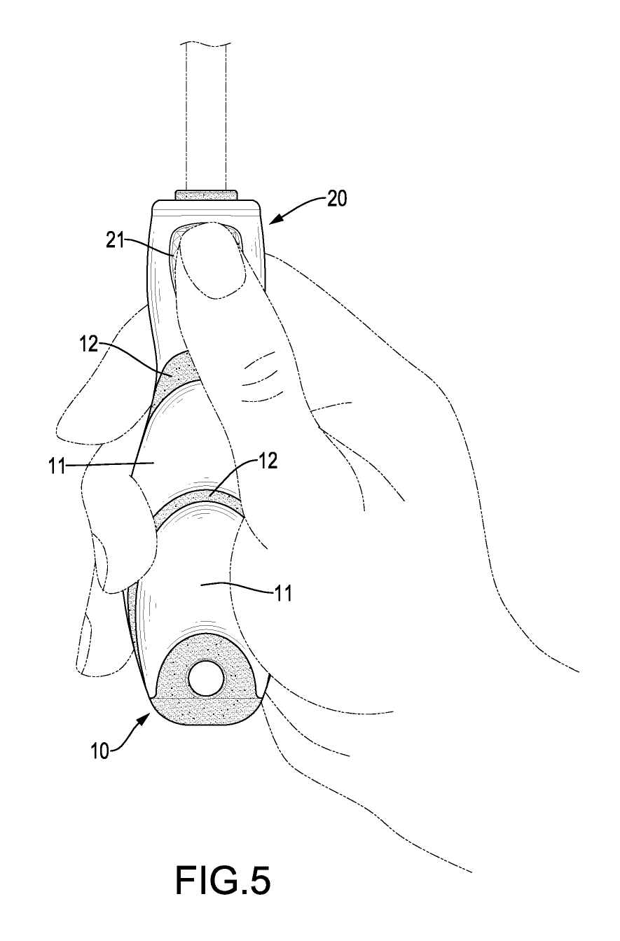

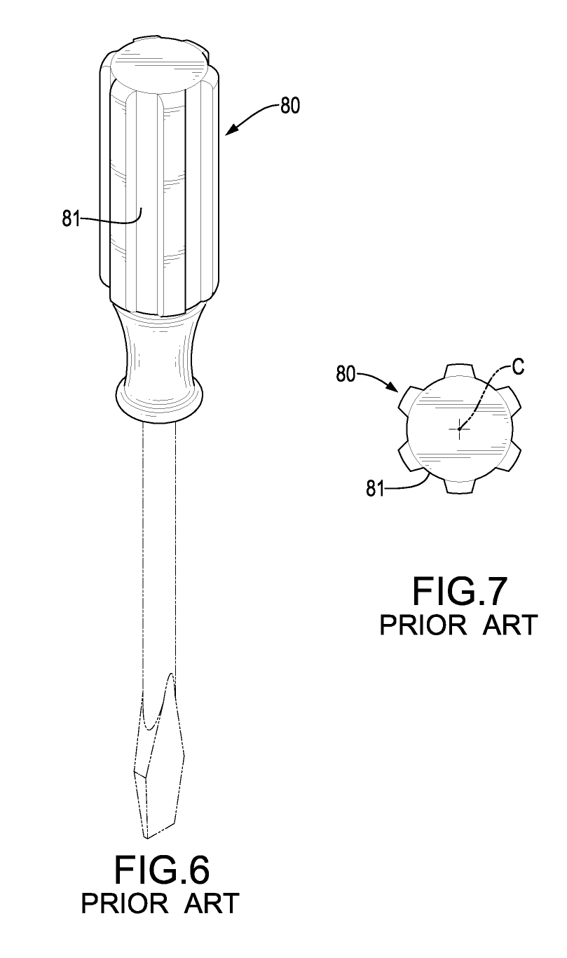

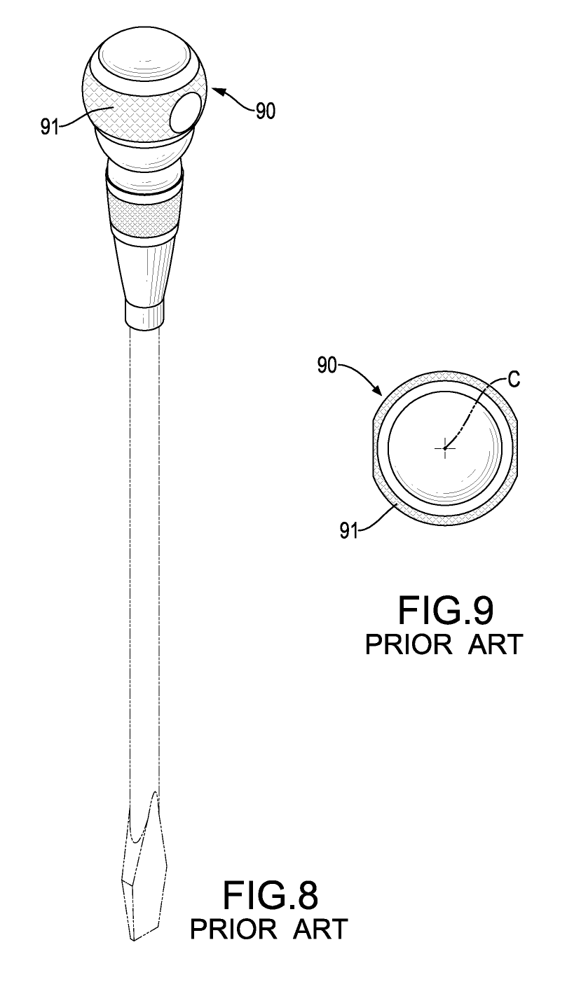

With reference to FIG. 5, the finger areas 21 are designed for being primarily pressed by a user's thumb. Accordingly, applying a thumb to one of the finger areas 21 facilitates the user's turning the handle when large forces are required.

From the above description, it is noted that the present invention has the following advantages:

1. Asymmetric design:

The cross section of the held section 10 has an asymmetric structure and is ergonomic, so the held section 10 is suitable for the user's hand to turn.

2. Easy grip due to height difference:

Height differences between the soft areas 11 and the hard areas 12 are formed when the held section 10 is held and the height differences help the user to grip firmly.

3. Pressing of fingers:

The finger areas 21 are mainly pressed by a user's fingers. Accordingly, a user can easily turn the handle in accordance with the present invention with the fingers, especially the thumb.

4. Easy manufacture:

Covering the grip with the soft pad is easy and processing conventional groove or rough surface is unnecessary. Accordingly, manufacturing the handle in accordance with the present invention is easy and convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A handle for a hand tool comprising:
a held section having
an outer surface;
a cross section;
at least one soft area formed on the outer surface of the held section; and
at least one hard area formed on the outer surface of the held section beside the at least one soft area; and
a connecting section connected with the held section and having
an outer surface;
an end surface opposite to the held section;
a finger area formed on the outer surface of the connecting section and having multiple notches; and
a shank hole formed in the end surface of the connecting section and having an axis, wherein the cross section of the held section is asymmetric relative to the axis of the shank hole.

2. The handle for a hand tool as claimed in claim 1, wherein
multiple finger areas are implemented and are arranged around the outer surface of the connecting section at intervals.

3. The handle for a hand tool as claimed in claim 2, wherein
three finger areas are implemented and a cross section of the connecting section is triangular.

4. The handle for a hand tool as claimed in claim 2, wherein each finger area protrudes from the outer surface of the connecting section.

5. The handle for a hand tool as claimed in claim 3, wherein each finger area protrudes from the outer surface of the connecting section.

6. The handle for a hand tool as claimed in claim 1, wherein
a rim of the cross section of the held section has
a first arc having a length and a curvature; and
a second arc having
a length shorter than that of the first arc; and
a curvature different from that of the first arc.

7. The handle for a hand tool as claimed in claim 2, wherein
a rim of the cross section of the held section has
a first arc having a length and a curvature; and
a second arc having
a length shorter than that of the first arc; and
a curvature different from that of the first arc.

8. The handle for a hand tool as claimed in claim 3, wherein
a rim of the cross section of the held section has
a first arc having a length and a curvature; and
a second arc having
a length shorter than that of the first arc; and
a curvature different from that of the first arc.

9. The handle for a hand tool as claimed in claim 4, wherein
a rim of the cross section of the held section has
a first arc having a length and a curvature; and
a second arc having
a length shorter than that of the first arc; and
a curvature different from that of the first arc.

10. The handle for a hand tool as claimed in claim 5, wherein
a rim of the cross section of the held section has
a first arc having a length and a curvature; and
a second arc having
a length shorter than that of the first arc; and
a curvature different from that of the first arc.
